(19) United States
(12) Patent Application Publication
(10) Pub. No.: US 2011/0254722 A1
(43) Pub. Date: Oct. 20, 2011

(54) REMOTE CONTROL SIGNAL RECEIVER AND ELECTRICAL APPARATUS

(75) Inventor: Takashi Naiki, Kyoto (JP)

(73) Assignee: ROHM CO., LTD., Kyoto (JP)

(21) Appl. No.: 13/072,038

(22) Filed: Mar. 25, 2011

(30) Foreign Application Priority Data
Apr. 15, 2010 (JP) 2010-093771

(51) Int. Cl. G08C 19/12

(52) U.S. Cl. 341/173

(57) ABSTRACT

A remote control signal receiver includes a receiving sensor to receive a remote control signal for remotely controlling an electrical apparatus, a receiving signal processor to judge whether or not the receiving sensor received the remote control signal, to recognize a direction included in the remote control signal and to generate an internal signal in response to the direction in accordance with the receiving signal, and an intermittent controller to drive the receiving sensor intermittently during a standby period of the electrical apparatus.

### CROSS-REFERENCE TO RELATED APPLICATIONS

This application claims the benefit of priority of Japanese patent application No. 2010-93771 (filing date: 2010 Apr. 15), which is incorporated herein by reference in its entirety.

### BACKGROUND

1. Field of the Invention

This disclosure relates to a remote control signal receiver to receive a remote control signal to remotely control an electrical apparatus.

2. Description of Related Art

Recently, as an effort to prevent a global warming by reducing energy consumption, a technique to reduce energy consumption of electrical apparatuses is globally implemented.

As an example of a conventional technique relates to above, it is disclosed in Japanese patent publication No. 2009-89322.

In an electrical apparatus used often (e.g., a television or an air conditioner), improvement of the efficiency of energy consumption to operate the apparatus is required. Furthermore, improvement of the efficiency of energy consumption used for a standby state (i.e., standby energy consumption) of an apparatus is required.

### SUMMARY

In some implementations, the disclosure provides a remote control signal receiver which is able to reduce a standby energy consumption of an electrical apparatus.

According to one aspect, a remote control signal receiver includes a receiving sensor to receive a remote control signal for remotely controlling an electrical apparatus, a receiving signal processor to judge whether or not the receiving sensor received the remote control signal, to recognize a direction included in the remote control signal and to generate an internal signal in response to the direction, in accordance with the receiving signal, and an intermittent controller to drive the receiving sensor intermittently during a standby period of the electrical apparatus.

Other features, elements, steps, advantages, and characteristics will be apparent from the following description, the drawings.

### BRIEF DESCRIPTION OF THE DRAWINGS

FIG. 1 is a block diagram showing an electrical apparatus in accordance with a first embodiment of the invention.

FIG. 2 is a schematic diagram showing an example of a remote control signal S0.

FIG. 3 is a schematic diagram showing an example of a first enable signal EN1.

FIG. 4 is a timing chart showing a first example of a signal receiving operation in accordance with a first embodiment.

FIG. 5 is a timing chart showing a second example of a signal receiving operation in accordance with a first embodiment.

FIG. 6 is a block diagram showing an electrical apparatus in accordance with a second embodiment of the invention.

FIG. 7 is a timing chart showing a first example of a signal receiving operation in accordance with a second embodiment.

FIG. 8 is a timing chart showing a second example of a signal receiving operation in accordance with a second embodiment.

FIG. 9 is a block diagram showing an electrical apparatus in accordance with a third embodiment of the invention.

FIG. 10 is a timing chart showing a first example of a signal receiving operation in accordance with a third embodiment.

FIG. 11 is a timing chart showing a second example of a signal receiving operation in accordance with a third embodiment.

FIG. 12 is a block diagram showing another example of an ON-OFF control technique of a receiving sensor 10.

### DETAILED DESCRIPTION OF PREFERRED EMBODIMENTS

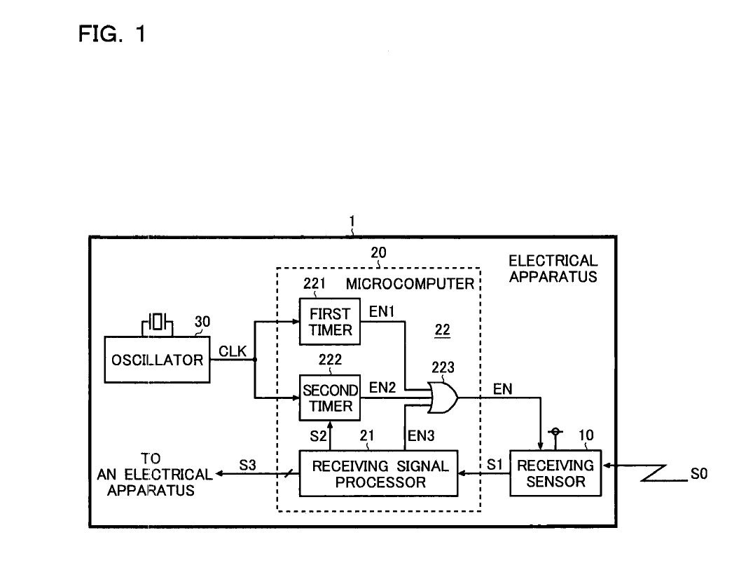

FIG. 1 is a block diagram showing an electrical apparatus in accordance with a first embodiment of the disclosure. The electrical apparatus 1 in accordance with the first embodiment includes a receiving sensor 10, a microcomputer 20, an oscillator 30, as a circuit block related to a receiving operation of a remote control signal S0. Although not illustrated in FIG. 1, the electrical apparatus 1 also includes a circuit to realize an original function of the electrical apparatus naturally. As examples of the electrical apparatus, a television, an air conditioner, an electrical apparatus, a game machine, and an illuminating apparatus are assumed.

The receiving sensor 10 is a circuit block to receive a remote control signal S0 for controlling the electrical apparatus 1 remotely. If the remote control signal S0 is an infrared signal, as the receiving sensor 10, a light receiving sensor including a photo diode or a photo transistor that has a peek of sensitivity in an infrared wavelength range can be used. The receiving sensor 10 includes an enable terminal. Therefore, the state of the receiving sensor 10 can be changed to an active state (a state of the receiving operation is permitted) from an inactive state (a state of the receiving operation is prohibited) in response to a predetermined enable signal EN provided from the enable terminal with a state of a power source supply is being continued.

The microcomputer 20 is an operation processing unit to control entire part of the electrical apparatus 1. To receive a remote control signal S0, the microcomputer 20 operates as a receiving signal processor 21 and an intermittent controller 22.

In accordance with a receiving signal S1 provided from the receiving sensor 10, the receiving signal processor 21 performs a receiving judgment (i.e., a generation of a receiving judgment signal S2), recognition of a direction included in the remote control signal S0, and a generation of an internal signal S3 in according to the direction. The receiving signal processor 21 recognizes a power ON direction or a power OFF direction included in the remote control signal S0, and generates a third enable signal EN3. The enable signal EN3 becomes a pulse signal which is raised to a high level when the power ON direction is recognized and lowered to a low level when the power OFF direction is recognized.

The intermittent controller 22 drives the receiving sensor 10 intermittently during a standby state (i.e., a state in which the controller is waiting for the remote control signal S0 including the power ON direction from the remote control signal transmitter not shown in figures) of the electrical apparatus 1. The intermittent controller 22 includes a first timer 221, a second timer 222, and a logical sum operation circuit 223.

The first timer 221 generates a first enable signal EN1 in accordance with a reference clock signal CLK. The first timer 221 counts the number of pulses of the reference clock signal CLK and maintains the first enable signal EN1 at a high level until the count value reaches a first target value (a target value to set an active period Tact of the receiving sensor 10) from zero. When the count value reaches the first target value, the first enable signal EN1 is lowered to a low level. Thereafter, the first timer 221 maintains the first enable signal EN1 at a low level until the count value reaches a second target value (e.g., a target value to set a cycle period Tcycle of an intermittent drive). The second target value is larger than the first target value. When the count value reaches the second target value, the enable signal EN1 is raised to a high level, the count value is reset to zero, and the foregoing sequential operations are repeated. Thus, the first enable signal EN1 becomes a pulse signal that converts between a high level and a low level with a predetermined cycle period Tcycle. The foregoing technique is an example for generating the first enable signal EN1, but operation is not limited to that technique.

The second timer 222 generates a second enable signal EN2 in accordance with the reference clock signal CLK and a receiving judgment signal S2. In accordance with the receiving judgment signal S2, the second timer 22 raises the enable signal EN2 to a high level and begins a count of the reference clock signal CLK when the receiving sensor 10 judges as receiving some kind of signal (i.e., a noise signal or a remote control signal of other electrical apparatus or a remote control signal which is supposed to be received by an electrical apparatus validly). During the count, the second timer 222 resets the count value to zero and maintains the second enable signal EN2 at a high level every time the receiving sensor 10 receives some kind of signal, in accordance with the receiving judgment signal S2. With respect to the second timer 222, when the count value reaches a third target value (e.g., a target value to set a standby period Twait) (i.e., when the receiving sensor 10 does not receive some kind of signal for a predetermined period Twait), lowers the second enable signal EN2 to a low level. Thus, when the receiving sensor 10 receives some kind of signal, the second enable signal EN2 is raised to a high level from a low level. Thereafter, until the receiving sensor 10 does not receive some kind of signal for the predetermined standby period Twait, the second enable signal EN2 is maintained at a high level. The foregoing sequential operations are example, a technique to generate the second enable signal EN2 or a logical level is not limited to the illustrated technique.

The logical sum operation circuit 223 performs a logical sum operation between the first enable signal EN1, the second enable signal EN2 and the third enable signal EN3, and provides a result as a conclusive enable signal EN to the receiving sensor 10. Thus, the enable signal EN becomes a high level if any one of the first enable signal EN1, the second enable signal EN2 or the third enable signal EN3 is a high level, and becomes a low level if all of the enable signals EN1, EN2, EN3 are low level. The receiving sensor 10 becomes an active state if the enable signal EN is a high level, and becomes an inactive state if the enable signal EN is a low level.

In FIG. 1, the receiving signal processor 21 and the intermittent controller 22 (i.e., the first timer 221, the second timer 222, and the logical sum operation circuit 223) are illustrated as separate circuit blocks, although both of them can be implemented by the microcomputer 20 as software operation.

The oscillator 30 generates the reference clock signal CLK of a predetermined frequency and provides the reference clock signal CLK to the microcomputer 20 (i.e., to the first timer 221 and the second timer 222).

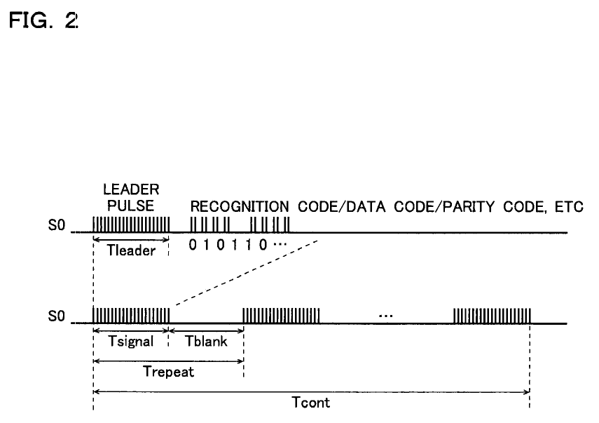

FIG. 2 is a schematic diagram showing an example of a remote control signal S0. Contents of the remote control signal S0 are illustrated in the upper portion of FIG. 2. As illustrated in the lower portion of FIG. 2, the remote control signal S0 is transmitted to the electrical apparatus 1 for a predetermined period repeatedly.

As illustrated in FIG. 2, with respect to the remote control signal S0, a leader pulse of a predetermined leader period Tleader is included in the head (beginning part) of the remote control signal S0. Following the leader pulse, a recognition code, a date code, and a parity code are included in the remote control signal S0.

As illustrated in lower portion of FIG. 2, the remote control signal S0 repeatedly includes signal period Tsignal to send the same directions with a predetermined blank period Tblank and a predetermined repeat cycle Trepeat for a predetermined continuous output period Tcont (e.g. 1 [s]). This construction makes it possible to improve reliability of the receiving sensor 10 to receive the remote control signal.

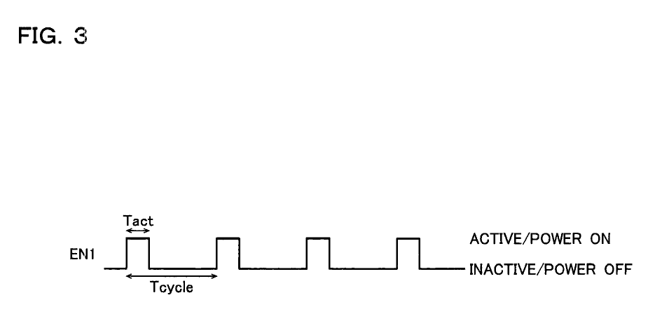

FIG. 3 is a schematic diagram showing an example of a first enable signal EN1. As described above, the first enable signal EN1 is a pulse signal which repeatedly converts between a high level and a low level with a predetermined cycle period Tcycle.

The intermittent controller 22 sets the cycle period Tcycle of the receiving sensor 10 to be shorter than the continuous output period Tcont (in reference to FIG. 2), and sets the active period Tact (a high level period of the first enable signal EN1) of the receiving sensor 10 to be longer than the blank period Tblank (=Trepeat−Tsignal, in reference to FIG. 2) of the remote control signal S0.

Thus, with respect to an intermittent drive (operation) of the receiving sensor 10, at least a part of the active period Tact of the receiving sensor 10 overlaps a part of the signal period Tsignal of the remote control signal S0 at least. Therefore, with respect to the receiving signal processor 21, a judgment of whether or not the receiving sensor 10 received some kind of signal can be performed. Furthermore, with respect to the intermittent controller 22, the enable signal EN can be generated to temporally interrupt the intermittent drive of the receiving sensor 10 and to maintain the receiving sensor 10 in an active state. Thus, failure to receive the remote control signal S0 can be prevented during the intermittent drive of the receiving sensor 10.

The intermittent controller 22 sets the cycle period Tcycle of the receiving sensor 10 to be shorter than the required response time (period) Treact of the electrical apparatus 1. The cycle period Tcycle is set to be smaller than a value calculated based on [Treact−Tstartup−Tdecode]. Accordingly, a user of the electrical apparatus does not experience a deterioration of a response time (response period) during the intermittent drive of the receiving sensor 10. Furthermore, a reduction in energy consumption for the electrical apparatus 1 can be realized.

With respect to formula [Treact−Tstartup−Tdecode] mentioned above, the response time Treact is a maximum permission period that is equal to a period from the time of pressing the power ON button of the remote control signal transmitter to a response time (period) of the electrical apparatus 1. The decode period Tdecode is a maximum required time (period) from recognition of the remote control signal S0 of the receiving signal processor 21 to generation of an internal signal S3 (activation signal) in response to the power ON direction. The start up period Tstartup is a time (period) from generation of an internal signal S3 (start up signal) in response to the power ON direction to completion of the start up of the electrical apparatus 1.

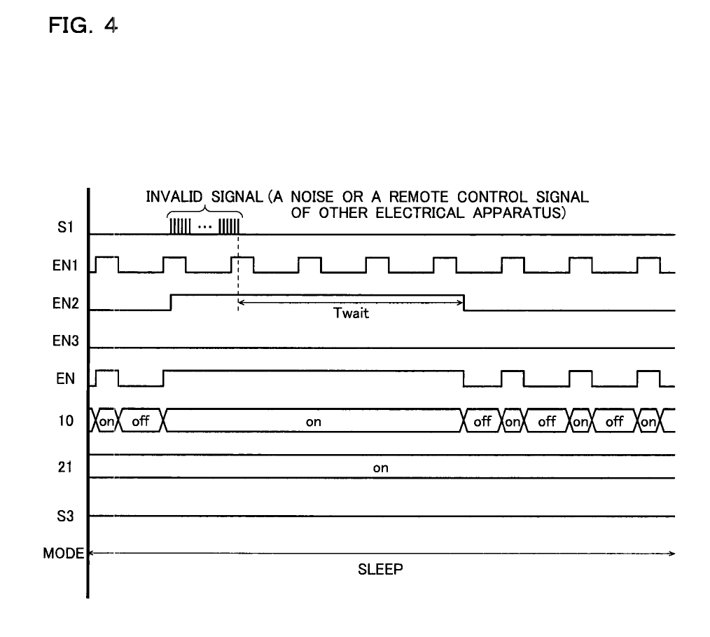

FIG. 4 is a timing chart showing a first example (an operation example in case of an invalid signal is received by the receiving sensor 10) of a receiving operation in accordance with a first embodiment, a receiving signal S1, a first enable signal EN1, a second enable signal EN2, a third enable signal EN3, an enable signal EN, an operation state of the receiving sensor 10, an operation state of the receiving signal processor 21, an internal signal S3, and an operation mode of the electrical apparatus 1 are illustrated.

During a sleep mode of the electrical apparatus 1 (i.e., a state in which the electrical apparatus 1 waits for a remote control signal S0 including the power ON direction, and a state in which the receiving signal processor 21 is activated), the receiving sensor 10 is driven intermittently by repeating an active state and an inactive state in response to the first enable signal EN1 basically.

During the receiving sensor 10 is activated, when some kind of signal is received by the receiving sensor 10, the second enable signal EN2 is raised to a high level. Thereafter, the receiving sensor 10 is maintained in an active state until no remote signal is received by the receiving sensor 10 for a predetermined standby period Twait.

Thus, if some kind of signal is received by the receiving sensor 10 during the intermittent drive of the receiving sensor 10, the intermittent controller 22 temporally interrupts the intermittent drive of the receiving sensor 10 and maintains the receiving sensor 10 in an active state. Thereafter, if no remote signal is received by the receiving sensor 10 for a predetermined standby period Twait, an intermittent drive of the receiving sensor 10 is restarted.

Thus, the intermittent controller 22 waits for some kind of signal during an intermittent drive of the receiving sensor 10, and if some kind of signal is received by the receiving sensor 10, the receiving sensor 10 maintains an active state and determines whether or not the received signal S1 is valid. Thus, the receiving sensor 10 can judge the validity or the invalidity of the receiving signal S1 accurately.

As for an example in FIG. 4, the received signal S1 provided from the receiving sensor 10 is an invalid signal (i.e., a noise signal or a remote control signal of another electrical apparatus). Therefore, after a predetermined standby period Twait passes, an intermittent drive of the receiving sensor 10 is restarted.

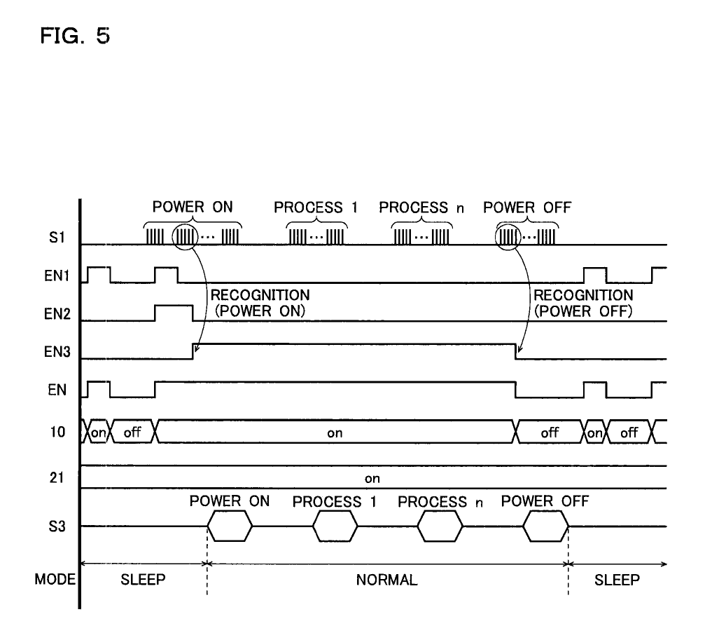

FIG. 5 is a timing chart showing a second example of a signal receiving operation in accordance with a first embodiment, the receiving signal S1, the first enable signal EN1, the second enable signal EN2, the third enable signal EN3, the enable signal EN, an operation state of the receiving sensor 10, an operation state of the receiving signal processor 21, the internal signal S3, and an operation mode of the electrical apparatus 1 are illustrated.

Same as the first example mentioned above, during a sleep mode of the electrical apparatus 1, the receiving sensor 10 is driven intermittently by repeating an active state and an inactive state in response to the first enable signal EN1, basically. If some kind of signal is received by the receiving sensor 10, the second enable signal EN2 is raised to a high level, and the receiving sensor 10 is maintained in an active state.

Thereafter, if the power ON direction included in the remote control signal S0 is recognized by the receiving signal processor 21, the internal signal S3 (start up signal) is generated in response to the power ON direction, and the electrical apparatus 1 becomes a normal operation mode from a sleep mode. When the power ON direction included in the remote signal S0 is recognized by the receiving signal processor 21, the third enable signal EN3 is raised to a high level. Thereafter, the third enable signal EN3 is maintained in a high level until the power OFF direction is recognized. Thus, during the electrical apparatus 1 is operating in a normal operation mode, the receiving sensor 10 is maintained in an active state. Therefore, during a normal operation mode of the electrical apparatus 1, when some directions (a direction to direct a process 1 to process n) included in the remote control signal S0 are provided to the electrical apparatus 10, these directions can be received without any delay.

If a power OFF direction included in the remote control signal S0 is recognized by the receiving signal processor 21, an internal signal S3 (a sleep mode transition signal) is generated in response to the power OFF direction, and the electrical apparatus 1 goes into a sleep mode from a normal operation mode, and the intermittent drive of the receiving sensor 10 is restarted.

As for an example in FIG. 5, when the third enable signal EN3 is raised to a high level, both the first timer 221 and the second timer 222 stop their operation, and both the first enable signal EN1 and the second enable signal EN2 are lowered to a low level. A construction of the disclosure is not restricted to the foregoing construction, both the first timer 221 and the second timer 222 can be maintained in an operation state.

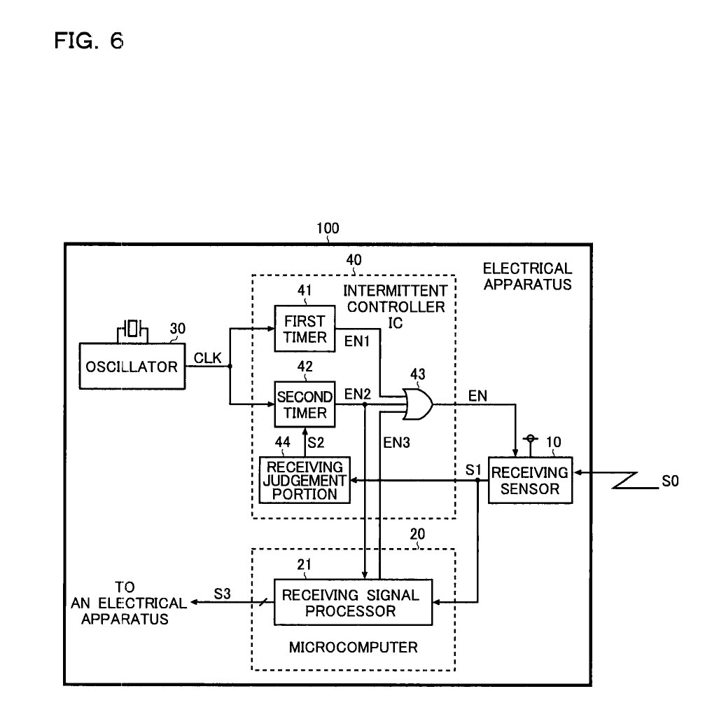

FIG. 6 is a block diagram showing an electrical apparatus in accordance with a second embodiment of the disclosure. The electrical apparatus 1 in accordance with the second embodiment has a similar construction to the electrical apparatus in accordance with the first embodiment. However, the receiving signal processor 21 is implemented by the microcomputer 20, and the intermittent controller 22 is implemented by a semiconductor device 40 (i.e., intermittent controller IC 40) formed apart from the microcomputer 20.

The intermittent controller IC 40 includes a first timer 41, a second timer 42, a logical sum operation circuit 43, and a receiving judgment portion 44. The first timer 41 and the second timer 42 and the logical sum operation circuit 43 correspond to the first timer 221 and the second timer 222 and the logical sum operation circuit 223 respectively.

The receiving judgment portion 44 is a circuit block to judge a reception (i.e., a generation of the receiving judgment signal S2) of a signal by the receiving sensor 10 in response to the receiving signal S1. The receiving judgment portion 44 judges a reception of signal by the receiving sensor 10 in accordance with a continuous period of an output of the receiving signal S1 or a duty of an output of the receiving signal S1. If the receiving signal S1 are continuously provided for a predetermined period or the output duty exceeds a predetermined threshold, the receiving judgment portion 44 determines that the receiving sensor 10 is receiving some kind of signal, and provides the receiving judgment signal S2 to the second timer 42. This construction makes it possible to simplify the construction of the circuit and to reduce a scale of the circuit and energy consumption.

With respect to the electrical apparatus 1 in accordance with the second embodiment, the receiving signal processor 21 is maintained in an inactive state until some kind of signal is received by the receiving sensor 10 during an intermittent drive of the receiving sensor 10 (i.e., until the second enable signal EN2 is raised to a high level). Thus, a receiving judgment by the receiving sensor 10 is judged by the intermittent controller IC 40, energy consumption of the microcomputer 20 and standby energy of the electrical apparatus 1 can be reduced compared to an electrical apparatus in accordance with the first embodiment.

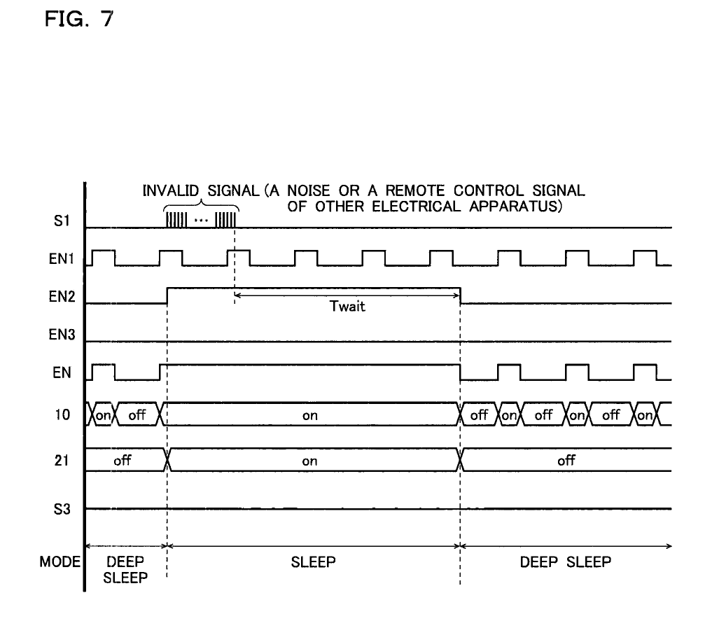

FIG. 7 is a timing chart showing a first example of a signal receiving operation in accordance with a second embodiment, the receiving signal S1, the first enable signal EN1, the second enable signal EN2, the third enable signal EN3, the enable signal EN, an operation state of the receiving sensor 10, an operation state of the receiving signal processor 21, the internal signal S3, and an operation mode of the electrical apparatus 1 are illustrated.

During the electrical apparatus 1 is in a deep sleep mode (i.e., a state when the apparatus is waiting for the remote control signal S0 including the power ON direction, and the receiving signal processor 21 is maintained in an inactive state), the receiving sensor 10 is driven intermittently by repeating an active state and an inactive state in response to the first enable signal EN1 basically.

During the receiving sensor 10 is activated, when some kind of signal is received in the receiving sensor 10, the second enable signal EN2 is raised to a high level. Thereafter, the receiving sensor 10 is maintained in an active state until no remote signal is received by the receiving sensor 10 for a predetermined standby period Twait. When the second enable signal EN2 is raised to a high level, the receiving signal processor 21 becomes an active state. Then the electrical apparatus 1 goes into a sleep mode (i.e., a state of waiting for a remote control signal S0 including a power ON direction, and the receiving signal processor 21 is activated). Then a judgment is performed by the receiving signal processor 21 to determine whether or not receiving signal S1 is a valid remote control signal S0.

In FIG. 7, the receiving signal S1 provided from the receiving sensor 10 is an invalid signal (e.g., a noise signal or a remote control signal of other electrical apparatus), the electrical apparatus 1 goes into a deep sleep mode again and an intermittent drive of the receiving sensor 10 is restarted.

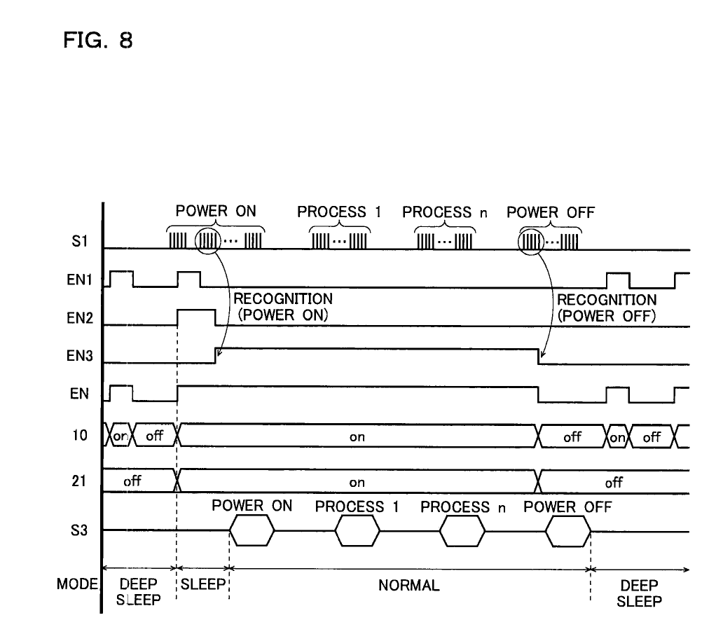

FIG. 8 is a timing chart showing a second example of a signal receiving operation in accordance with a second embodiment, the receiving signal S1, the first enable signal EN1, the second enable signal EN2, the third enable signal EN3, the enable signal EN, an operation state of the receiving sensor 10, an operation state of the receiving signal processor 12, the internal signal S3, and an operation of the electrical apparatus 1 are illustrated.

Same as the first example, during a deep sleep mode of the electrical apparatus 1, the receiving sensor 10 is driven intermittently by repeating an active state and an inactive state in response to the first enable signal EN1. If some kind of signal is received by the receiving sensor 10, the second enable signal EN2 is raised to a high level, and the receiving sensor 10 is maintained in an active state. When the second enable signal EN2 is raised to a high level, the receiving signal processor 21 becomes an active state, and the electrical apparatus 1 goes into a sleep mode. Then a judgment is performed by the receiving signal processor 21 to determine whether or not the receiving signal S1 is a valid remote control signal S0.

Thereafter when the power ON direction included in the remote control signal S0 is recognized by the receiving signal processor 21, an internal signal S3 (start up signal) is generated in response to the power ON direction. Then the electrical apparatus 1 becomes a normal operation mode from the sleep mode. When the power ON direction included in the remote control signal S0 is recognized by the receiving signal processor 21, the third enable signal EN3 becomes a high level. Thereafter, the third enable signal EN3 is maintained in a high level until the power OFF direction is recognized by the receiving signal processor 21. Thus, during a normal operation mode of the electrical apparatus 1, the receiving sensor 10 is always maintained in an active state. Therefore, during a normal operation mode of the electrical apparatus 1, when the remote signal S0 including some directions (a direction to direct a process 1 to process n) are inputted to the apparatus 1, these directions can be received without any delay.

If a power OFF direction included in the remote control signal S0 is recognized by the receiving signal processor 21, an internal signal S3 is generated in response to the power OFF direction, the electrical apparatus 1 goes into a deep sleep mode from a normal operation mode, and the intermittent drive (intermittent operation) of the receiving sensor 10 is restarted.

In FIG. 8, when the third enable signal EN3 is raised to a high level, both the first timer 41 and the second timer 42 stop their operation, and both the first enable signal EN1 and the second enable signal EN2 become a low level. A construction of the disclosure is not restricted to the foregoing construction, both the first timer 41 and the second timer 42 can be maintained in an operation state.

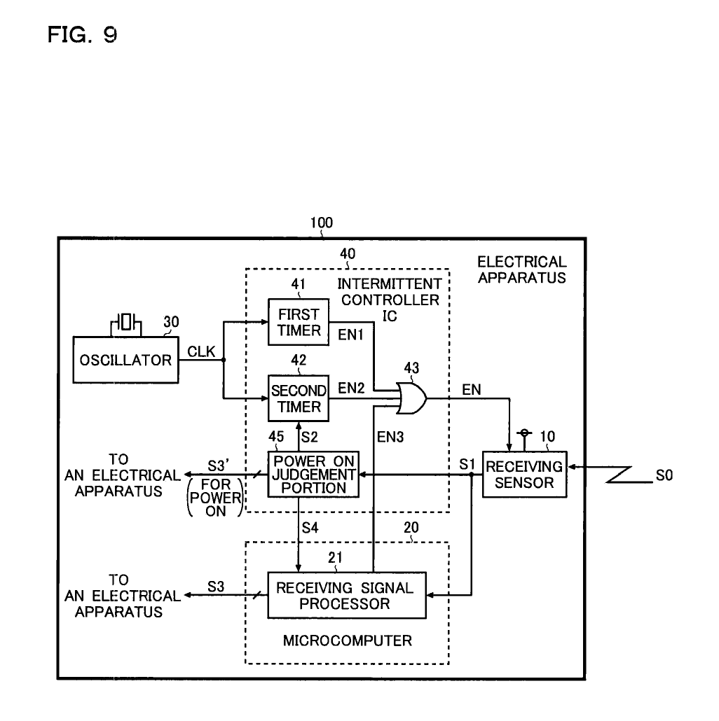

FIG. 9 is a block diagram showing an electrical apparatus in accordance with a third embodiment of the disclosure. The electrical apparatus 1 in accordance with a third embodiment has a similar construction to the electrical apparatus 1 in accordance with a second embodiment of the disclosure. However, the intermittent controller IC 40 includes a power ON judgment portion 45 instead of the receiving judgment portion 44.

Same as the receiving judgment portion 44, the power ON judgment portion 45 judges reception of a signal by the receiving sensor 10 (i.e., a generation of the receiving judgment signal S2) in accordance with a continuous period of an output of the receiving signal S1 or a duty of an output of the receiving signal S1. The power ON judgment portion 45 also recognizes a power ON direction (i.e., a generation of the power ON judgment signal S2) included in the remote control signal S0, and also generates an internal signal S3′ in response to the power ON direction.

With respect to the electrical apparatus in accordance with the third embodiment, the receiving signal processor 21 is maintained in an inactive state until a remote control signal S0 including the power ON direction is received by the receiving sensor 10 during an intermittent drive (operation) of the receiving sensor 10 (i.e., until the power ON judgment signal S4 becomes a high level). Thus, not only a receiving judgment by the receiving sensor 10, but also a recognition of a power ON direction included in the remote control signal S0 and a generation of an internal signal S3′ in response to a power ON direction is performed by the intermittent controller IC 40, energy consumption of the microcomputer 20 and standby energy of the electrical apparatus 1 can be reduced compared to an electrical apparatus in accordance with the second embodiment.

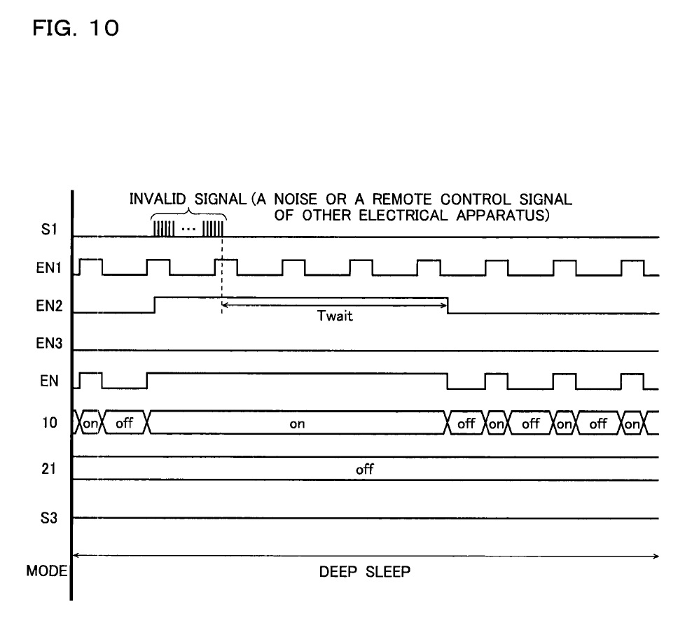

FIG. 10 is a timing chart showing a first example (i.e., an operation example when an invalid signal is received by the receiving sensor 10) of a signal receiving operation in accordance with a third embodiment, the receiving signal S1, the first enable signal EN1, the second enable signal EN2, the third enable signal EN3, the enable signal EN, an operation state of the receiving sensor 10, an operation state of the receiving signal processor 21, the internal signal S3, and an operation mode of the electrical apparatus 1 are illustrated.

During a deep sleep mode of the electrical apparatus 1 (i.e., a state of waiting for a remote control signal S0 including a power ON direction, and a state the receiving signal processor 21 is inactivated), the receiving sensor 10 is driven intermittently by repeating an active state and an inactive state in response to the first enable signal EN1.

During the receiving sensor 10 is activated, when some kind of signal is received in the receiving sensor 10, the second enable signal EN2 is raised to a high level. Thereafter, the receiving sensor 10 is maintained in an active state until no remote signal is received by the receiving sensor 10 for a predetermined standby period Twait. Even when the second enable signal EN2 is raised to a high level, the receiving signal processor 21 does not change to an active state, and a determination as to whether or not the receiving signal S0 is valid is judged by the power ON judgment portion 45. Thus, the electrical apparatus 1 is maintained in a deep sleep mode continuously.

In FIG. 10, the receiving signal S1 provided from the receiving sensor 10 is an invalid signal (e.g., a noise signal or a remote control signal of other electrical apparatus). Therefore, after a predetermined standby period Twait, an intermittent drive (operation) of the receiving sensor 10 is restarted.

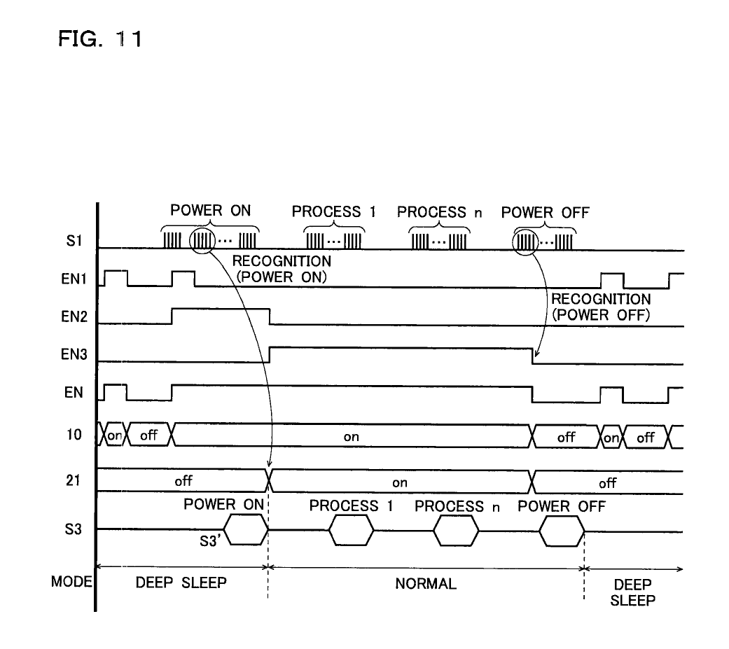

FIG. 11 is a timing chart showing a second example (i.e., an operation example when an invalid signal is received by the receiving sensor 10) of a signal receiving operation in accordance with a third embodiment, the receiving signal S1, the first enable signal EN1, the second enable signal EN2, the third enable signal EN3, the enable signal EN, an operation state of the receiving sensor 10, an operation state of the receiving signal processor 21, the internal signal S3, and an operation mode of the electrical apparatus 1 are illustrated.

Same as the first example, during a deep sleep mode of the electrical apparatus 1, the receiving sensor 10 is driven intermittent by repeating an active state and an inactive state in response to the first enable signal EN1. If some kind of signal is received by the receiving sensor 10, the second enable signal EN2 is raised to a high level, and the receiving sensor 10 is maintained in an active state. Even when the second enable signal EN2 becomes a high level, the receiving signal processor 21 does not change to an active state. A determination whether or not the receiving signal S0 is valid is judged by the power ON judgment portion 45. Thus, the electrical apparatus 1 is maintained in a deep sleep mode continuously.

Thereafter, if the power ON direction included in the remote control signal S0 is recognized by the power ON judgment portion 45, an internal signal S3′ (start up signal) is generated in response to the power ON direction and the electrical apparatus 1 changes to a normal operation mode from a deep sleep mode. When the power ON direction included in the remote signal S0 is recognized by the power ON judgment portion 45, the receiving signal processor 21 changes to an active state, and the third enable signal EN3 becomes a high level. Thereafter, recognition of directions included in the remote control signal S0 and generation of an internal signal S3 in response to the directions are performed by the receiving signal processor 21. The third enable signal EN3 is maintained in a high level until the power OFF direction is recognized. Thus, when the electrical apparatus 1 is operating in a normal operation mode, the receiving sensor 10 is maintained in an active state. Therefore, during a normal operation mode of the electrical apparatus 1, when some directions (a direction to direct a process 1 to process n) included in the remote control signal S0 are provided to the electrical apparatus 10, these directions can be received without any delay.

If a power OFF direction included in the remote control signal S0 is recognized by the receiving signal processor 21, an internal signal S3 (a sleep mode transition signal) in response to the power OFF direction is generated, and the electrical apparatus 1 goes into a deep sleep mode from a normal operation mode, and the intermittent drive (operation) of the receiving sensor 10 is restarted.

In FIG. 11, when the third enable signal EN3 becomes a high level, both the first timer 41 and the second timer 42 stop their operation, and both the first enable signal EN1 and the second enable signal EN2 become a low level. A construction of the disclosure is not restricted to the foregoing construction, both the first timer 41 and the second timer 42 can be maintained in an operation state.

In one aspect, a remote control signal receiver includes a receiving sensor to receive a remote control signal for remotely controlling an electrical apparatus, a receiving signal processor to judge whether or not the receiving sensor received the remote control signal, to recognize a direction included in the remote control signal and to generate an internal signal in response to the direction, in accordance with the receiving signal, and an intermittent controller to drive the receiving sensor intermittently during a standby period of the electrical apparatus.

In some implementations, the intermittent controller is arranged to interrupts the intermittent drive of the receiving sensor temporarily when the receiving sensor receives some kind of signal during the intermittent drive of the receiving sensor, and maintains an activated state of the receiving sensor, then restarts the intermittent drive of the receiving sensor when the receiving sensor does not receive some kind of signal for a predetermined period.

In some implementations, both the receiving signal processor and the intermittent controller are implemented by a microcomputer.

In some implementations, the receiving signal processor is implemented by a microcomputer and the intermittent controller is implemented by a semiconductor device separate from the microcomputer.

In some implementations, the intermittent controller includes a receiving judgment portion that judges reception of a signal by the receiving sensor in accordance with the receiving signal, and the receiving signal processor is maintained in an inactive state until some kind of signal is received by the receiving signal processor during the intermittent drive of the receiving sensor.

In some implementations, the receiving judgment portion judges a receiving of a signal in accordance with a continuous period of an output of the receiving signal or a duty of an output of the receiving signal.

In some implementations, the intermittent controller includes a power judgment portion to determine whether or not the receiving sensor received the remote control signal, to recognize a power ON direction included in the remote control signal, and to generate an internal signal in response to the power ON direction, in accordance with the receiving signal. The receiving signal processor is maintained in an inactive state until the remote control signal including a power ON direction is received by the receiving sensor during the intermittent drive of the receiving sensor.

In some implementations, the power judgment portion judges a receiving of a signal in accordance with a continuous period of an output of the receiving signal or a duty of an output of the receiving signal.

In some implementations, the remote control signal includes the same directions repeatedly with a predetermined blank period for a predetermined continuous output period.

In some implementations, the intermittent controller sets a cycle period of the receiving sensor to be shorter than the continuous output period, and sets an active period of the receiving sensor to be longer than the blank period of the remote control signal.

In some implementations, the intermittent controller sets a cycle period of the receiving sensor to be shorter than the response period required for the electrical apparatus during an intermittent drive of the receiving sensor.

In some implementations, a receiving operation of the receiving sensor is permitted or prohibited in response to an enable signal inputted from the intermittent controller.

In some implementations, the remote control signal receiver includes a switch which conducts or cuts off a power supply line in response to an enable signal from the intermittent controller.

In some implementations, the receiving sensor receives an infrared signal as the remote control signal.

In some implementations, the receiving sensor receives a high frequency signal as the remote control signal.

According to the another aspect, an electrical apparatus includes a remote control signal receiver. The remote control signal receiver includes a receiving sensor to receive a remote control signal for remotely controlling an electrical apparatus, a receiving signal processor to judge whether or not the receiving sensor received the remote control signal, to recognize a direction included in the remote control signal and to generate an internal signal in response to the direction, in accordance with the receiving signal, and an intermittent controller to drive the receiving sensor intermittently during a standby period of the electrical apparatus.

According to a remote control signal receiver of the disclosure, energy consumption of a receiving sensor can be reduced, and energy consumption of an electrical apparatus can be reduced,

The disclosure is a technique to realize a reduction of energy consumption of a remote control signal receiver provided to an electrical apparatus.

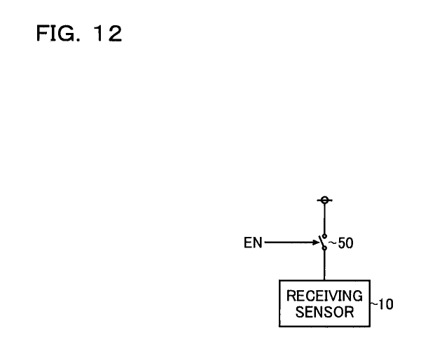

In the foregoing description, the receiving sensor 10 includes an enable terminal and permission or prohibition of the receiving sensor 10 is determined in response to an enable signal EN provided from the intermittent controller IC 40. However, the foregoing implementation is an example, and the description is not restricted to the illustrated example. For example, as for a technique to control the ON-OFF state of the receiving sensor 10, a switch 50 can be provided to determine conduction or cut off of the power supply line to the receiving sensor 10 in response to an enable signal EN illustrated in FIG. 12.

Also, in the foregoing implementations, with respect to the receiving sensor 10, an infrared signal is used as the remote control signal S0. However, in some implementations, a RF (Radio Frequency) signal can be used as the remote control signal S0.

A number of implementations of the invention have been described. Nevertheless, various modifications can be made without departing from the spirit and scope of the invention. Accordingly, other implementations are within the scope of the claims.

### LIST OF REFERENCE NUMERALS

1 electrical apparatus
10 receiving sensor
20 microcomputer
21 receiving signal processor
22 intermittent controller
221 first timer
222 second timer
223 logical sum operation circuit
30 oscillator
40 intermittent controller IC
41 first timer
42 second timer
43 logical sum operation circuit
44 receiving judgment portion
45 power ON judgment portion
50 switch

1. A remote control signal receiver comprising:
a receiving sensor to receive a remote control signal for remotely controlling an electrical apparatus;
a receiving signal processor to judge whether or not the receiving sensor received the remote control signal, to recognize a direction included in the remote control signal, and to generate an internal signal in response to the direction, in accordance with the receiving signal; and
an intermittent controller to drive the receiving sensor intermittently during a standby period of the electrical apparatus.

2. The remote control signal receiver according to claim 1, wherein the intermittent controller is arranged to interrupts the intermittent drive of the receiving sensor temporarily when the receiving sensor receives some kind of signal during the intermittent drive of the receiving sensor, and maintains an activated state of the receiving sensor, then restarts the intermittent drive of the receiving sensor when the receiving sensor does not receive some kind of signal for a predetermined period.

3. The remote control signal receiver according to claim 1, wherein both the receiving signal processor and the intermittent controller are implemented by a microcomputer.

4. The remote control signal receiver according to claim 1, wherein the receiving signal processor is implemented by a microcomputer and the intermittent controller is implemented by a semiconductor device separate from the microcomputer.

5. The remote control signal receiver according to claim 4, wherein the intermittent controller includes a receiving judgment portion that judges reception of a signal by the receiving sensor in accordance with the receiving signal, and the receiving signal processor is maintained in an inactive state until some kind of signal is received by the receiving signal processor during the intermittent drive of the receiving sensor.

6. The remote control signal receiver according to claim 5, wherein the receiving judgment portion judges a receiving of a signal in accordance with a continuous period of an output of the receiving signal or a duty of an output of the receiving signal.

7. The remote control signal receiver according to claim 4, wherein the intermittent controller comprises:
a power judgment portion to determine whether or not the receiving sensor received the remote control signal, to recognize a power ON direction included in the remote control signal, and to generate an internal signal in response to the power ON direction, in accordance with the receiving signal;
wherein the receiving signal processor is maintained in an inactive state until the remote control signal including a power ON direction is received by the receiving sensor during the intermittent drive of the receiving sensor.

8. The remote control signal receiver according to claim 7, wherein the power judgment portion judges a receiving of a signal in accordance with a continuous period of an output of the receiving signal or a duty of an output of the receiving signal.

9. The remote control signal receiver according to claim 1, wherein the remote control signal includes the same directions repeatedly with a predetermined blank period for a predetermined continuous output period.

10. The remote control signal receiver according to claim 9, wherein the intermittent controller sets a cycle period of the receiving sensor to be shorter than the continuous output period, and sets an active period of the receiving sensor to be longer than the blank period of the remote control signal.

11. The remote control signal receiver according to claim 10, wherein the intermittent controller sets a cycle period of the receiving sensor to be shorter than the response period required for the electrical apparatus during an intermittent drive of the receiving sensor.

12. The remote control signal receiver according to claim 1, wherein a receiving operation of the receiving sensor is permitted or prohibited in response to an enable signal inputted from the intermittent controller.

13. The remote control signal receiver according to claim 1 comprises:
a switch which conducts or cuts off a power supply line in response to an enable signal from the intermittent controller.

14. The remote control signal receiver according to claim 1, wherein the receiving sensor receives an infrared signal as the remote control signal.

15. The remote control signal receiver according to claim 1, wherein the receiving sensor receives a high frequency signal as the remote control signal.

16. An electrical apparatus comprising:
a remote control signal receiver;
wherein the remote control signal receiver comprises:
a receiving sensor to receive a remote control signal for remotely controlling an electrical apparatus;
a receiving signal processor to judge whether or not the receiving sensor received the remote control signal, to recognize a direction included in the remote control signal, and to generate an internal signal in response to the direction, in accordance with the receiving signal; and
an intermittent controller to drive the receiving sensor intermittently during a standby period of the electrical apparatus.
